(19) United States
(12) Patent Application Publication
(10) Pub. No.: US 2019/0375334 A1
(43) Pub. Date: Dec. 12, 2019

(54) VEHICLE STORAGE DEVICE

(71) Applicant: GM GLOBAL TECHNOLOGY OPERATIONS LLC, Detroit, MI (US)

(72) Inventor: Daniel W. Whitman, Howell, MI (US)

(21) Appl. No.: 16/001,088

(22) Filed: Jun. 6, 2018

(51) Int. Cl. B60R 5/04; B60R 9/06; B62D 33/02

(52) U.S. Cl. CPC B60R 5/048; B62D 33/02; B60R 9/065

(57) ABSTRACT

A vehicle storage device includes a plurality of planar panels and a plurality of hinges pivotally connecting each of the plurality of planar panels to an adjacent one of each of the plurality of planar panels.

### FIELD

The present disclosure relates to a vehicle storage device for a vehicle cargo area.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Automotive vehicles such as cars, trucks, sport utility vehicles (SUVs), and the like have become ubiquitous and are relied upon to transport people. These vehicles are also relied upon to transport a wide range of cargo. In order to transport cargo, these vehicles typically include dedicated cargo storage areas such as trunks, beds, and other similar payload space. These cargo storage areas often include utility space for storing items such as spare tires, emergency and maintenance equipment, tools, and the like. Cargo storage areas are utilized to store and transport a wide array of items including child care equipment, large pieces of luggage, school and work bags, grocery, and other items. Because cargo storage space is often a very desirable feature of a vehicle, they are often designed as an open, cavernous area in order to maximize the storage capacity.

However, while large, cavernous cargo spaces are suitable and preferred for providing maximum cargo area, these cavernous spaces present a problem with respect to securing cargo during transport and removing cargo from the vehicle. Because the open cargo storage areas often do not provide a suitable means of securing the cargo, the cargo is allowed to slide, roll, tumble, or otherwise move around during transport. The movement of unsecured cargo presents a heightened risk of the cargo being damaged or destroyed. This risk of damage or destruction is particularly high for fragile and special care items, e.g., groceries, liquids, and the like. The movement of unsecured cargo also allows cargo to move to an inconvenient location, e.g., a forward portion of the cargo storage area, such that removal of the item from the vehicle is inconvenient.

### SUMMARY

In an exemplary aspect, a vehicle storage device includes a plurality of planar panels and a plurality of hinges pivotally connecting each of the plurality of planar panels to an adjacent one of each of the plurality of planar panels.

In another exemplary aspect, the device includes a plurality of magnets.

In another exemplary aspect, each of the plurality of magnets is embedded within a body of a corresponding one of the plurality of planar panels.

In another exemplary aspect, each of the plurality of magnets is embedded within the body of a corresponding one of the plurality of planar panels adjacent to one of the plurality of hinges that connects the corresponding one of the plurality of planar panels to an adjacent one of the plurality of planar panels.

In another exemplary aspect, at least a first pair of the plurality of magnets is embedded within one of the plurality of planar panels and a second pair of the plurality of magnets is embedded within an adjacent one of the plurality of panels that is hinged to the one of the plurality of planar panels.

In another exemplary aspect, each of the plurality of magnets is embedded within a body of the corresponding one of the plurality of planar panels a predetermined distance from an edge of the plurality of planar panels that is hinged to an adjacent one of the plurality of planar panels.

In another exemplary aspect, each of the plurality of panels forms a rectangular planar panel and each of the plurality of magnets is embedded within the body of a corresponding one of the plurality of planar panels adjacent to a corner of the rectangularly shaped one of the plurality of planar panels.

In another exemplary aspect, the device includes a textured surface on at least one side of each of the plurality of planar panels.

In another exemplary aspect, each of the plurality of hinges biases the plurality of planar panels to a flat configuration.

In another exemplar aspect, the device includes a plurality of hook and loop fasteners positioned on a side of each of the plurality of planar panels.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of a cargo area of a vehicle including an exemplary embodiment of a vehicle storage device;

FIG. 2 is a cross-section view of another exemplary embodiment of a vehicle storage device;

FIG. 3A is a cross-section view of yet another exemplary embodiment of a vehicle storage device in a first configuration;

FIG. 3B is a cross-section view of the exemplary embodiment of a vehicle storage device of FIG. 3A in a second configuration;

FIG. 3C is a cross-section view of the exemplary embodiment of a vehicle storage device of FIG. 3A in a third configuration;

FIG. 4A is a perspective view of a cargo area of a vehicle including the vehicle storage device of FIG. 1 in a first configuration;

FIG. 4B is a perspective view of a cargo area of a vehicle including the vehicle storage device of FIG. 1 in a second configuration;

FIG. 4C is a perspective view of a cargo area of a vehicle including the vehicle storage device of FIG. 1 in a third configuration; and

FIG. 4D is a perspective view of a cargo area of a vehicle including the vehicle storage device of FIG. 1 in a fourth configuration.

### DETAILED DESCRIPTION

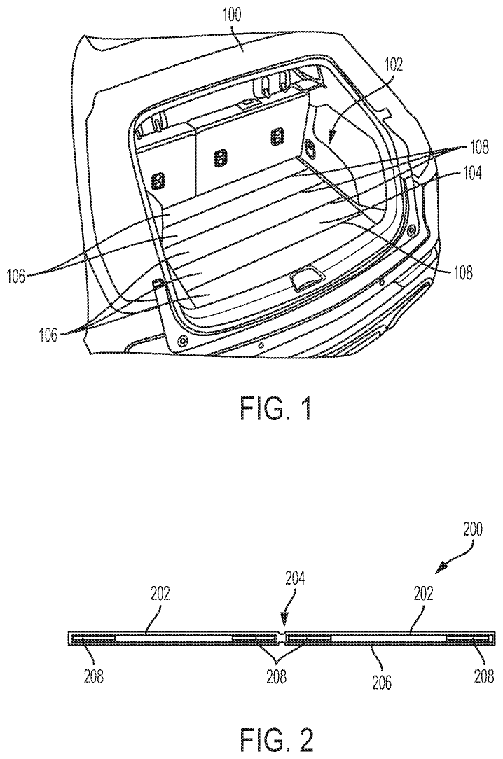

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures, FIG. 1 is a perspective view of a cargo area 102 of a vehicle 100 including an exemplary embodiment of a vehicle storage device 104.

The cargo area 102 of the vehicle 100 includes a load floor (not shown) on which the vehicle storage device 104 is positioned. In this configuration, the vehicle storage device 104 forms a flat surface on which items may be positioned. In this manner and in this configuration, the vehicle storage device 104 may serve the same function as a cargo area load floor and be positioned within the cargo area 102 without diminishing the volume of the cargo area 102, nor interfering with anything positioned within the cargo area 102. This is in stark contrast to conventional vehicle storage devices which may occupy valuable cargo volume and, therefore, may need to be removed from the vehicle and returned to the vehicle depending upon the items positioned within the vehicle cargo area. In an exemplary embodiment, the vehicle storage device 104 includes a plurality of planar panels 106 which are pivotally attached to each other by a plurality of hinges 108 along corresponding adjacent edges.

Referring now to FIG. 2 a cross-section view of another exemplary embodiment of a vehicle storage device 200 is illustrated. The vehicle storage device 200 includes a plurality of planar panels 202 which are pivotally attached along adjacent edges by a hinge 204. The planar panels 202 may be formed of a generally rigid material which maintains a planar configuration. A flexible material coating 206 is molded over the planar panels 202 and a portion of that coating 206 forms the pivoting hinge 204. Alternatively, the flexible material coating 206 may include a fabric that may serve as an outer surface of the planar panels 202 and which may also bridge the gap between adjacent edges of the planar panels 202 and, thereby, form a hinge between the planar panels 202.

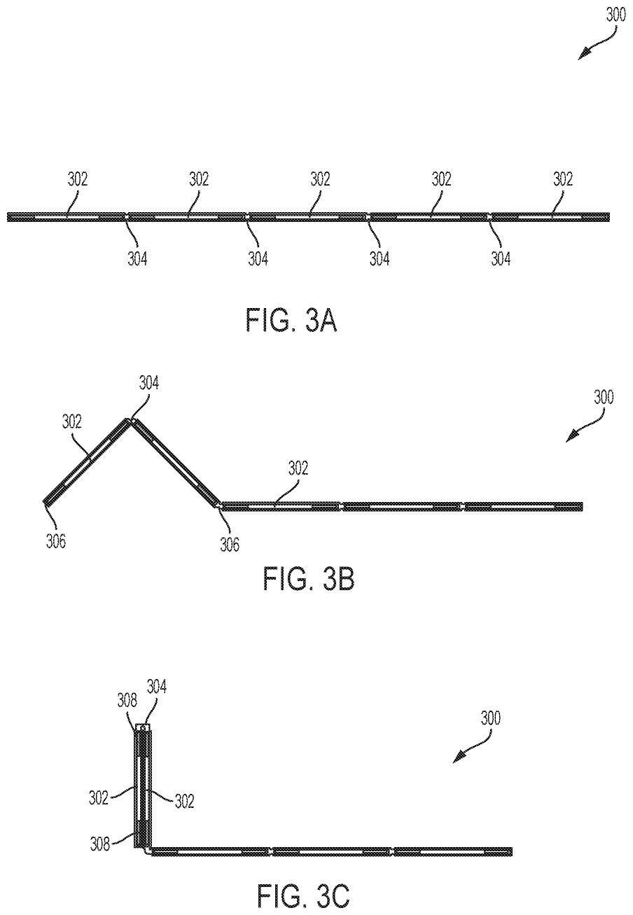

In an exemplary embodiment, the vehicle storage device 200 may further include a plurality of magnets 208 that are embedded within the plurality of panels 202. The plurality of magnets 208 may be positioned adjacent the edges of the plurality of panels 202. Preferably, the magnets 208 are each positioned a predetermined distance from corresponding adjacent panel edges such that they align when the panels pivot about the hinge 204 as will be described with reference to FIGS. 3A to 3C.

FIG. 3A is a cross-section view of another exemplary embodiment of a vehicle storage device 300 in a first configuration. The vehicle storage device 300 has a substantially identical construction as that of the vehicle storage device 200 of FIG. 2. The only differences being the vehicle storage device 200 of FIG. 2 includes two planar panels 202 and a single hinge 204 while the vehicle storage device 300 of FIGS. 3A to 3C includes five planar panels 302 and four hinges 304. It is to be understood that the vehicle storage device of the present disclosure may include any number of planar panels and hinges without limitation.

FIG. 3A illustrates a first configuration in which the vehicle storage device 300 is in a flat configuration. In this first, flat configuration the vehicle storage device 300 may be positioned in a cargo area of a vehicle and serve as a load floor without diminishing the volume of the cargo area and without interfering with anything positioned within the cargo area.

FIG. 3B illustrates the vehicle storage device 300 in a second configuration. Two of the plurality of planar panels 302 are pivoted about a hinge 304 and, thereby, form two legs of a triangle where the third leg of the triangle may be formed by a load floor (not shown) of a cargo area in a vehicle. In this configuration, the bottom edges 306 of the two planar panels 302 contact a cargo area load floor and the friction between the edges 306 and the underlying load floor may establish a rigid structure that ensures that this configuration is maintained. In a preferred embodiment, the surface of the planar panels 302 may have a textured surface with interacts with a surface of the underlying load floor to improve friction. In this manner, the vehicle storage device 300 may be easily configured to provide a barrier to objects placed within a vehicle cargo area.

FIG. 3C illustrates the vehicle storage device 300 in yet another configuration. In this configuration, the two planar panels 302 pivot about the hinge 304 until their opposing faces contact each other. The magnets 308 which are embedded in each of the planar panels 302 are placed into close proximity such that the magnetic field between corresponding pairs of magnets 308 operate to securely hold the planar panels 302 together. To ensure alignment of the magnets 308 when opposing faces of the planar panels 302 are positioned against each, the magnets 308 are positioned within each panel a predetermined distance from corresponding edges of the planar panels 302.

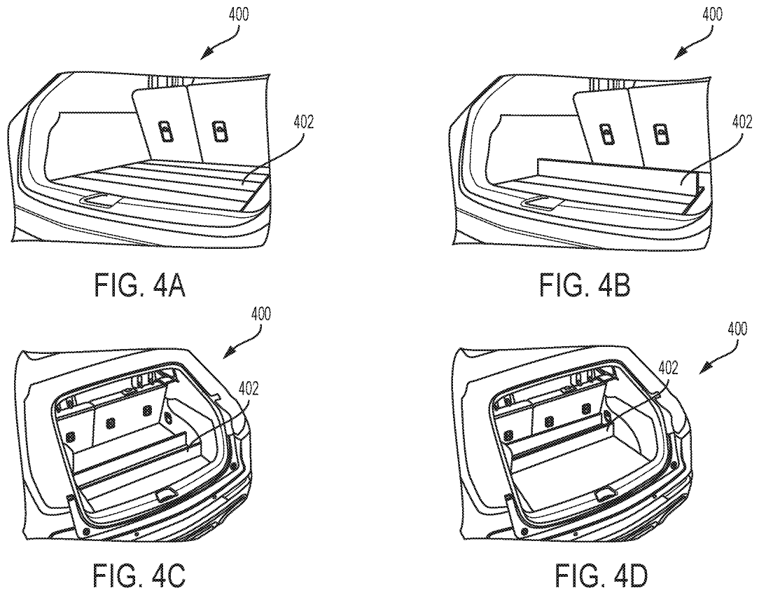

FIGS. 4A through 4D illustrate a vehicle cargo area 400 in which an exemplary embodiment vehicle storage device 402 in accordance with the present disclosure is positioned. Each of FIGS. 4A through 4D illustrate a different configuration for the vehicle storage device 402. It is to be understood that the vehicle storage device 402 may be configured in any number of configurations without limitation. FIG. 4A illustrates the vehicle storage device 402 in a completely flat configuration. In this configuration, the vehicle storage device 402 may form a load floor of the vehicle cargo area 400 and the vehicle storage device 402 does not occupy any significant volume of the vehicle cargo area 400. In other words, the full capacity of the vehicle cargo area 400 remains even with the vehicle storage device 402 positioned within the vehicle cargo area 400.

FIG. 4B illustrates another configuration for the vehicle storage device 402 that is positioned within the vehicle cargo area 400. In this configuration, two of the planar panels of the vehicle storage device 402 have been pivoted about an adjoining hinge such that the planar panels abut each other. In this configuration, the vehicle storage device 402 forms a wall within the vehicle cargo area 400 which may then act to control the positioning of objects placed within the vehicle cargo area 400.

FIG. 4C illustrates yet another configuration of the vehicle storage device 402 that is positioned within the vehicle cargo area 400. In this configuration, two pairs of planar panels have been pivoted about corresponding adjacent hinges. In this manner, the vehicle storage device 402 forms two walls that are spaced apart, which divides the load floor of the vehicle cargo area 400 into three areas. Objects may then be selectively positioned on different sides of the walls and, thereby, separate and control the positioning of objects within the vehicle cargo area 400. FIG. 4D illustrates the vehicle cargo area 402 in which the vehicle storage device 402 having the same configuration of FIG. 4C where the vehicle storage device 402 in FIG. 4D has been re-positioned within the vehicle cargo area 400. Thus, it is understood that the vehicle storage device may have any number of different configurations and be easily moved around and positioned within the vehicle cargo area 400.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle storage device, comprising:
a plurality of planar panels; and
a plurality of hinges pivotally connecting each of the plurality of planar panels to an adjacent one of each of the plurality of planar panels.

2. The device of claim 1, further comprising a plurality of magnets.

3. The device of claim 2, wherein each of the plurality of magnets is embedded within a body of a corresponding one of the plurality of planar panels.

4. The device of claim 3, wherein each of the plurality of magnets is embedded within the body of a corresponding one of the plurality of planar panels adjacent to one of the plurality of hinges that connects the corresponding one of the plurality of planar panels to an adjacent one of the plurality of planar panels.

5. The device of claim 3, wherein at least a first pair of the plurality of magnets is embedded within one of the plurality of planar panels and a second pair of the plurality of magnets is embedded within an adjacent one of the plurality of panels that is hinged to the one of the plurality of planar panels.

6. The device of claim 3, wherein each of the plurality of magnets is embedded within a body of the corresponding one of the plurality of planar panels a predetermined distance from an edge of the plurality of planar panels that is hinged to an adjacent one of the plurality of planar panels.

7. The device of claim 3, wherein each of the plurality of panels forms a rectangular planar panel and wherein each of the plurality of magnets is embedded within the body of a corresponding one of the plurality of planar panels adjacent to a corner of the rectangularly shaped one of the plurality of planar panels.

8. The device of claim 1, further comprising a textured surface on at least one side of each of the plurality of planar panels.

9. The device of claim 1, wherein each of the plurality of hinges biases the plurality of planar panels to a flat configuration.

10. The device of claim 1, further comprising a plurality of hook and loop fasteners positioned on a side of each of the plurality of planar panels.

11. A vehicle storage device comprising:
a rigid material forming a plurality of planar panels; and
a flexible material covering the plurality of planar panels and forming a plurality of hinges between adjacent edges of the plurality of planar panels.

12. The device of claim 11, wherein the flexible material comprises one of a fabric, a plastic, and a rubber material.

13. The device of claim 11, wherein the flexible material is molded over the plurality of planar panels.

14. The device of claim 11, wherein the flexible material biases the plurality of planar panels to a flat configuration.

15. The device of claim 11, further comprising a plurality of magnets.

16. The device of claim 15, wherein each of the plurality of magnets is embedded within a body of a corresponding one of the plurality of planar panels.

17. The device of claim 16, wherein each of the plurality of magnets is embedded within the body of a corresponding one of the plurality of planar panels adjacent to one of the plurality of hinges that connects the corresponding one of the plurality of planar panels to an adjacent one of the plurality of planar panels.

18. The device of claim 16, wherein at least a first pair of the plurality of magnets is embedded within one of the plurality of planar panels and a second pair of the plurality of magnets is embedded within an adjacent one of the plurality of panels that is hinged to the one of the plurality of planar panels.

19. The device of claim 16, wherein each of the plurality of magnets is embedded within a body of the corresponding one of the plurality of planar panels a predetermined distance from an edge of the plurality of planar panels that is hinged to an adjacent one of the plurality of planar panels.

20. The device of claim 16, wherein each of the plurality of panels forms a rectangular planar panel and wherein each of the plurality of magnets is embedded within the body of a corresponding one of the plurality of planar panels adjacent to a corner of the rectangularly shaped one of the plurality of planar panels.
